(19) United States
(12) Patent Application Publication
(10) Pub. No.: US 2014/0110924 A1
(43) Pub. Date: Apr. 24, 2014

(54) PROTECTION DEVICE

(71) Applicant: Dainese S.p.A., Molvena (VI) (IT)

(72) Inventor: Luigi Ronco, Molvena (Vicenza) (IT)

(73) Assignee: Dainese S.p.A., Molvena (VI) (IT)

(21) Appl. No.: 14/126,786

(22) PCT Filed: Jun. 28, 2012
(86) PCT No.: PCT/IB2012/053302

§ 371 Date: Dec. 16, 2013

(30) Foreign Application Priority Data
Jun. 30, 2011 (IT) VR2011A000135

(51) Int. Cl. B60R 21/231

(52) U.S. Cl. CPC B60R 21/231
USPC 280/743.1; 156/60

(57) ABSTRACT

A protection device for the protection of a user is described. The protection device has an inflatable member in which an internal chamber is defined. The inflatable member includes at least one first layer and one second layer overlapped and joined by an adhesive layer. The adhesive layer includes polyurethane deriving from polycarbonate and/or polyurethane deriving from polyether.

The present disclosure refers to a protection device for the protection of a user. The protection device, commonly called air-bag, includes an inflatable member adapted to protect from impacts and/or falls a passenger or driver of a motor vehicle or an alike user, in a sports and/or work activity.

More specifically, the protection device according to the present disclosure may be used to protect the user from impacts, following falls or slipping, when said user is performing an activity and/or when he/she is aboard a means of transport, such as e.g. a vehicle, or any other means of transport, like a horse or other animal, a sporting apparatus, like a pair of skis or a bob, or alike means of transport.

The protection device may be mounted aboard the means of transport and/or worn on by a user.

In the last years, as a result of a constant research in vehicle driving safety, a plurality of protection devices including inflatable members, so-called air bags, have been contrived to protect from impacts a user, who e.g. is aboard a vehicle. The inflatable member, or inflatable bag, is made, e.g., of a multilayer structure, i.e. it is a bag having a multilayer, or wall including plural overlapped layers, guaranteeing a suitable resistance to inflation.

The inflatable member, in a resting condition, is arranged deflated and folded in a housing of the vehicle, at vehicle parts potentially concerned by impacts, i.e. against which, in case of accident, the user can come in contact, or in a garment pocket.

Moreover, at the instant of an impact, a slipping or of an accident in general, the inflatable bag is set in fluid communication with a compressed gas source, like a canister.

A need stemming from the use of said inflatable bag arranged in a folded condition is that of guaranteeing a sudden inflation, even following a prolonged stay in a vehicle housing, or in a garment pocket.

In connection with this need, in order to check the effectiveness of the protection device over time, the inflatable member may be subjected beforehand to strict testing, including, among others, so-called aging tests.

Aging tests are tests in which a storage protracted over time is simulated, e.g. by re-creating storage conditions under extreme temperature and pressure, or other extreme operating condition, like high humidity or a so-called salty mist (corrosive environment).

In particular, after a stay under such extreme conditions, it is checked whether the inflatable member can still be inflated appropriately.

It follows that an inflatable member should, on the one hand, be made of a material of a resistance sufficient to resist a sudden impact of the gas at the instant of an inflation, yet at the same time be made of a material durable over time, in order to be deployed and inflated, even after having remained for a long time, e.g. in a folded condition.

The present disclosure is based on the observation by the Inventor of the present patent application that the selection of an appropriate glue, adhesive, or adhesive layer for the joining of layers, which form the wall of the inflatable member, represents a relevant factor for passing the aging tests, without compromising other features of resistance of the inflatable member. From said observation, in order to overcome said technical problem and/or meet the above-mentioned need, a protection device according to claim 1, a use of an adhesive layer according to claim 7, and a method according to claim 9 are provided. Secondary features of the subject-matter of the disclosure are defined in the corresponding dependent claims.

In practice, according to an aspect of the present disclosure, an adhesive layer including, or made of polyurethane deriving from polycarbonate and/or polyurethane deriving from polyether is used to fix two layers or portions of an inflatable member. Said adhesive layer has excellent properties of resistance to detachment from the respective portions of the inflatable member. In practice, the portions of inflatable member remain joined over time, and allow a keeping of the integrity and functionality of the inflatable member over time.

In one embodiment, the two layers (joined by the adhesive layer) are adjacent layers of the inflatable member defining a wall of the inflatable member.

It is pointed out that, in the present description and in the following claims, by the expression “polyurethane deriving from polycarbonate” and “polyurethane deriving from polyether”, or alike expressions such as “based on” or “having a matrix of”, it is meant a polyurethane obtained by reaction of a diisocyanate with a polyol, wherein, in turn, said polyol is derived from, based on, or having a matrix of polycarbonate and/or polyether. Such a polyol may also be referred to as polyol polycarbonate and polyol polyether.

Other advantages, features and operation modes of the subject-matter of the present disclosure will be made evident in the following detailed description of some preferred embodiments thereof, given by way of a non-limiting example. However, it is evident how each embodiment may entail one or more of the advantages listed above; in any case, it is however not required for each embodiment to concomitantly entail all of the advantages listed.

Reference will be made to the figures of the annexed drawings, wherein:

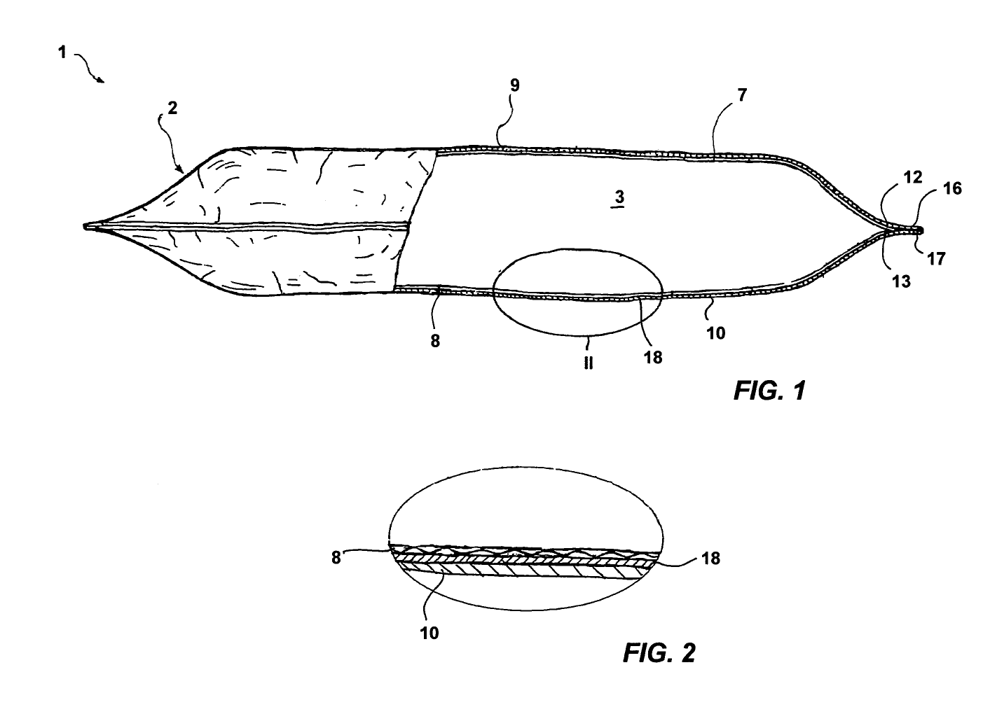

FIG. 1 shows a partially sectional side view of a personal protection device according to the present disclosure;

FIG. 2 shows a detail II of FIG. 1;

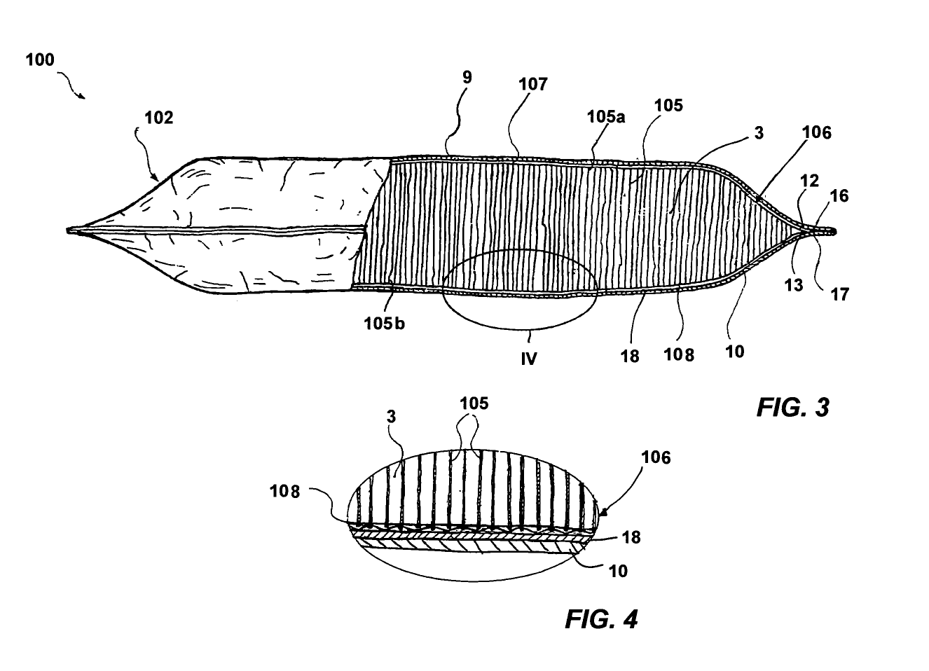

FIG. 3 shows a partially sectional view of a personal protection device according to the present disclosure;

FIG. 4 shows a detail IV of FIG. 3;

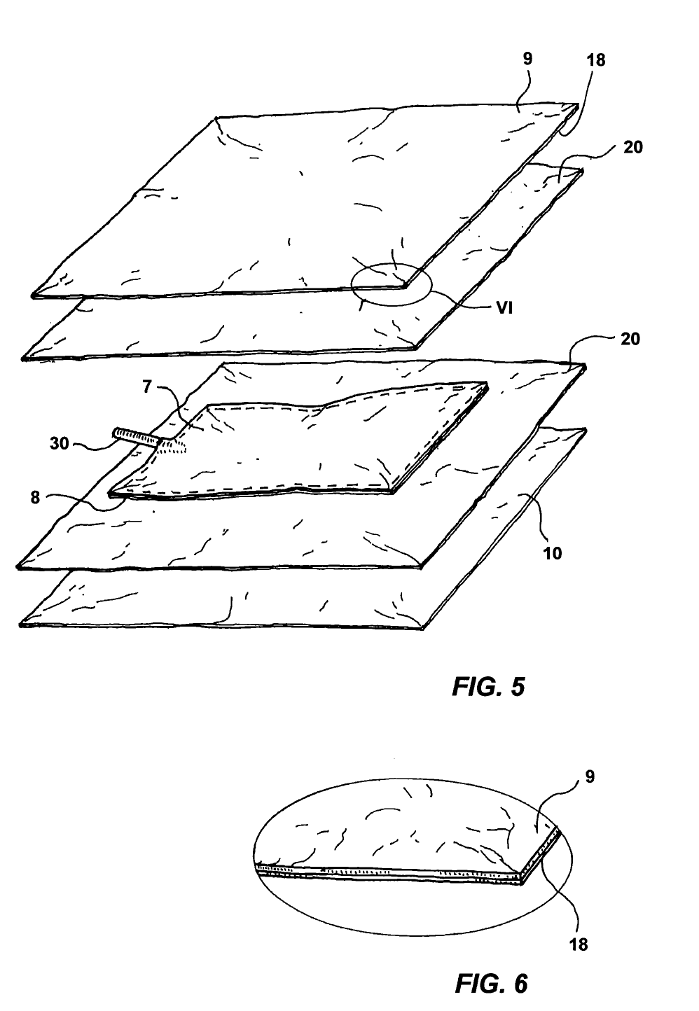

FIG. 5 shows a view with detached parts of a personal protection device according to the present disclosure;

FIG. 6 shows a view of a detail VI of FIG. 5;

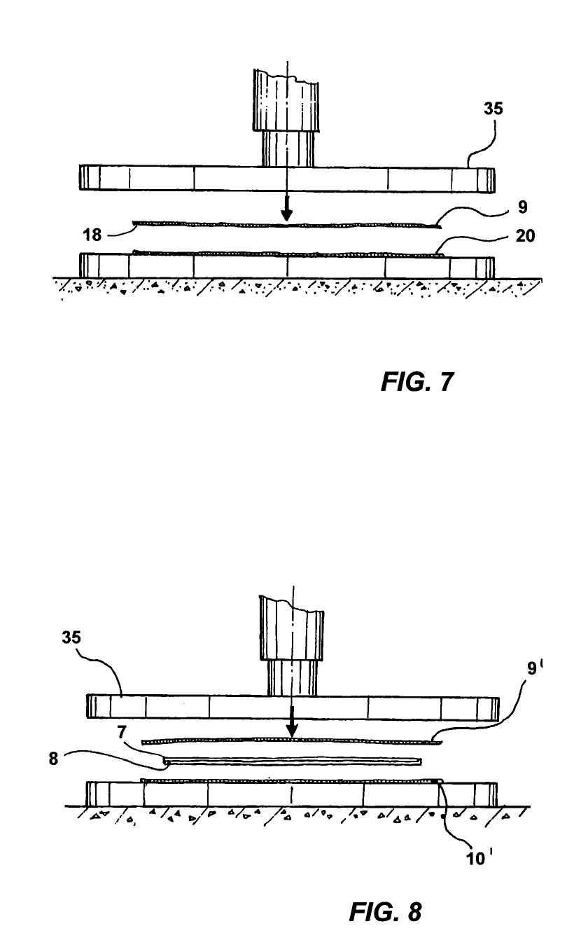

FIG. 7 shows a view of a step of manufacturing a protection device according to the present disclosure;

FIG. 8 shows a view of a step of manufacturing a protection device according to the present disclosure;

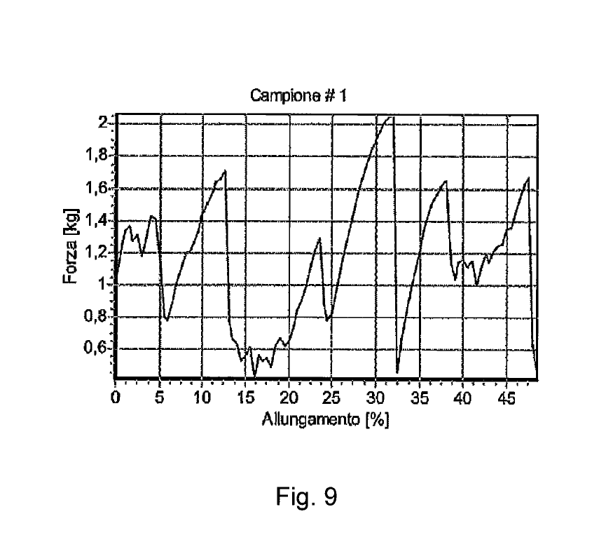

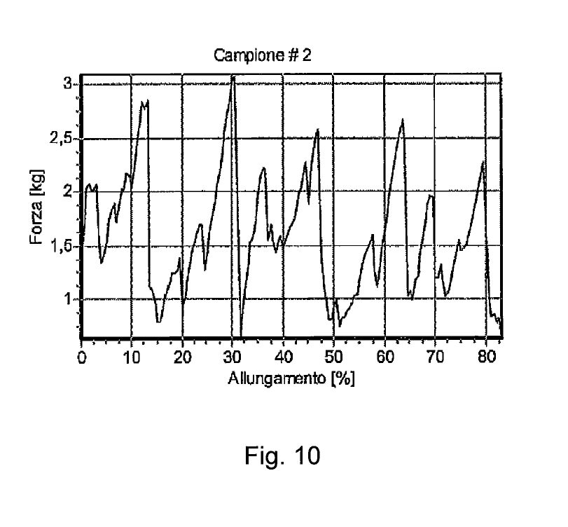

FIGS. 9-10 show respective diagrams related to the results of tests conducted on a wall of an inflatable member manufactured according to the known art;

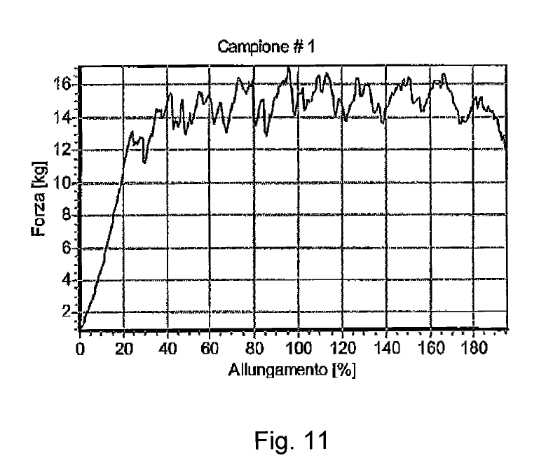

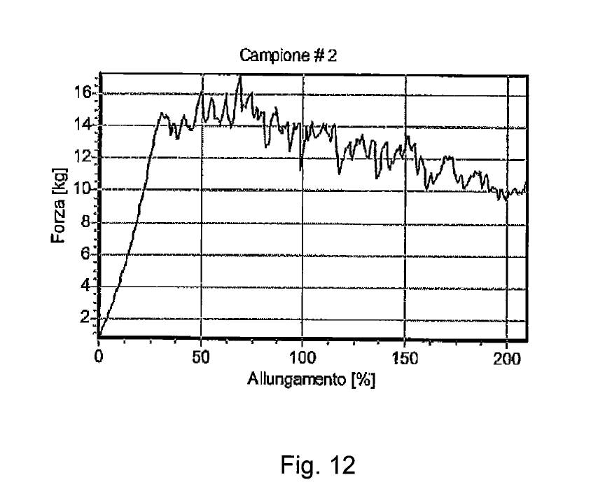

FIGS. 11-12 show respective diagrams related to the results of tests conducted on a wall of an inflatable member manufactured according to the present disclosure.

Referring to the annexed figures, by reference number 1 a personal protection device according to the present disclosure is denoted, in accordance with a first embodiment.

In particular, the protection device 1 comprises an inflatable member 2, an internal chamber 3 being defined in said inflatable member 2, said inflatable member 2 being adapted, in case of an impact or knock, to assume substantially a first resting condition, or deflated condition, and a second active condition, or inflated condition. The inflatable member 2 comprises at least two first layers or internal layers 7, 8, made of a fabric or other material, which are opposed the one with respect to the other.

The inflatable member 2 further comprises two second layers, or external layers 9, 10, made of a sheet of soft and gas-tight material, e.g. of polyamide or polyurethane. The external layers 9, 10 are opposed the one with respect to the other.

In practice, each first layer 7, 8 is adherent to a respective internal face of a second layer 9, 10, or external layer. Each first layer 7, 8 and each second layer 9, 10 define a wall, or wall portion, of the inflatable member 2.

The two internal layers 7, 8 are, e.g., pieces originally distinct, and subsequently joined or seamed perimetrically with each other along the respective perimetrical edges 12, 13. The two external layers 9, 10 have a surface extension greater than the two internal layers 7, 8 and are perimetrically joined with each other along the respective perimetrical edges 16, 17 which protrude with respect to the two internal layers 7, 8.

Each internal layer 7, 8 is overlapped and glued to a respective external layer 9, 10, by at least one adhesive layer 18. According to an aspect of the present disclosure, the adhesive layer 18 includes, or is a polyurethane resin or glue (or polyurethane) obtained by reaction of a diisocyanate (e.g., aromatic or aliphatic) and of a polyol, in turn deriving from polycarbonate or polyether; i.e., it is a polyurethane resin based on, having a matrix of, or from polycarbonate or polyether.

In general, it was found that the use of such an adhesive layer 18 to join portions of an inflatable member 2 allows to obtain an improved resistance to detachment under extreme conditions of temperature, pressure, humidity and salty mist, with respect to a generic polyurethane resin, different from that based on polycarbonate or polyether.

In one embodiment, the adhesive layer 18 is interposed and fixed between the internal layer 7, 8 and the external layer 9, 10 in a same operation step.

In a variant embodiment the external layer 9, 10 is preliminarily associated to the adhesive layer 18 to define a laminate sheet. In such sheet, the adhesive layer 18 is homogeneously distributed on the external layer 9, 10, e.g. by spreading or coupling. Then, the external layer 9, 10 is joined to the internal layer 7, 8.

Referring to FIGS. 3 and 4, it is illustrated a protection device in accordance with a second embodiment. Elements and parts of the present second embodiment having the same function and the same structure of the elements and parts of the aforedescribed embodiment keep the same reference number and will not be detailed again.

In particular, the protection device 100 differs from the protection devices of the preceding embodiments mainly for the internal layers. In this embodiment, the inflatable member 102 of the protection device 100 includes, besides the two external layers 9, 10, two internal layers 107, 108, which are part of a textile structure 106. In particular, the textile structure 106 includes, besides the two internal layers 107, 108, a plurality of wires 105 having respective opposite ends 105a, 105b interlaced with the two internal layers 107, 108.

The internal layers 107, 108 are meshes, e.g. made of polyester or polyamide, and the wires 105 are flexible tie members, made, e.g., of polyester or polyamide.

Each internal layer 107,108 lines the respective external layer 9, 10. Even more specifically, each internal layer 107, 108 is stably fixed to the internal face of the external layer 9, 10, by the adhesive layer 18, which is visible in FIG. 4 and that is identical to the aforedescribed one.

In particular, it has to be understood that the adhesive layer 18 may be interposed and fixed between the internal layer 107, 108 and a respective external layer 9, 10 in a same operation step, or preliminarily associated to the external layer 9, 10, e.g. by spreading, and then fixed to the internal layer 107, 108.

Referring to FIGS. 5 and 6, a mode of manufacturing a protection device is illustrated, in which said mode is applicable for the manufacturing both of the protection device of FIG. 1 and of the protection device of FIG. 3.

In this embodiment, two layers of adhesive may be provided.

In particular, there are provided the adhesive layer 18, preliminarily associated onto the external layer 9, 10, e.g. by spreading or coupling, and another thermoadhesive layer 20, interposed between the internal layer 7, 8 and the adhesive layer 18.

In practice, the thermoadhesive layer 20 is arranged in contact with the adhesive layer 18 preliminarily spread or coupled on the external layer 9, 10.

The manufacturing mode is as follows.

Two internal layers 7, 8 are prearranged in an opposed position; said layers are overlapped and joined the one with the other along the perimeter to form, and enclose, the internal chamber 3.

A cannula 30, or duct, is arranged between the internal layers 7, 8 and comes out of the inside of the chamber 3 to connect the chamber 3 to inflating means, (not depicted in the drawings) and allow an introduction of an inflation fluid in the inflatable member 2. The inflating means may also be included inside the inflatable member 2.

The two internal layers 7, 8 are interposed between two external layers 9, 10 of soft gas-tight material, e.g. said laminate mentioned above, in which each external layer 9, 10 is provided beforehand with the adhesive layer 18 based on polyurethane deriving from polycarbonate and/or polyether.

The external layers 9, 10 have a surface extension greater than the internal layers 7, 8.

In the example, the external layers 9, 10 are glued to the respective internal layers 7, 8 by means of the thermoadhesive layer 20, in the example a generic and conventional polyurethane resin not derived from polycarbonate or polyether, or a resin derived from polycarbonate or polyether, having a thickness of about 100 μm, utilizing a press 35 at 185° C. (which, e.g., works at temperatures comprised between about 140° C. and 185° C., preferably at about 180-185° C.) to foster adhesion and mutual gluing.

In particular, each thermoadhesive layer 20 is fixed to the adhesive layer 18 of the external layer 9, 10, by press 35, in a first step of the process as illustrated in FIG. 7, to form a composite layer 9′, 10′ (FIG. 8). Then, each composite layer 9′, 10′ is overlapped and fixed to the internal layer 7, 8.

Peripheral edges of the composite layers 9′, 10′, at which the internal layers 7, 8 are not present, are directly glued the one on the other in a gas-tight manner. Coupling may occur according to other thermocoupling techniques known in the field.

As anticipated, it was found that the use of the adhesive layer based on polyurethane/polycarbonate or polyurethane/polyether gives satisfactory results in the aging tests, without compromising other features of resistance of the inflatable member 2. In particular, excellent results were had in connection with a resistance of the adhesive layer 18 to detachment from the respective external layer 9, 10 and/or from the internal layer 7,8, thereby allowing the keeping of the features of the inflatable member over time.

It follows that, even after a long stay in a resting condition, the inflatable member 2 has an intact structure suitable for inflation.

Moreover, it was found that the combined use of a thermoadhesive layer 20 and the adhesive layer 18 gives satisfactory results. In particular, the thermoadhesive layer 20 has a high adherence with the laminate (a gluing occurring directly with the adhesive layer 18); at the same time, the thermoadhesive layer 20 can penetrate the internal layers 7, 8, so as to fill any pores of the internal layers 7, 8. Thus, a high impermeability of the inflatable member 2 is guaranteed, without seal loss, thanks to a high distribution of adhesive.

As anticipated above, this embodiment may be manufactured in conjunction with the aforedescribed embodiment, therefore there is nothing to prevent the gluing in the press 35 from occurring only with the adhesive layer 18.

In connection with the inflation, it has to be pointed out that the inflation and the activation modes, though an aspect particularly relevant for an effective operation of the device, are described in less detail, being methods essentially already known to a technician in the field of protection of an individual from unforeseen impacts.

In particular, the inflating means are controlled by a control unit on the basis of a detection of the state of the vehicle/driver system; e.g., said control unit may implement a fall prediction system allowing a timely identification of a fall event and a reliable prediction thereof by means of accelerometric sensors integral to the vehicle (or to the driver) and an unit for processing the signals produced by the sensors themselves.

As an alternative, the device according to the present disclosure also finds application by utilizing an actuating cable connected to a vehicle driven by a user, which cable actuates the inflation of the inflatable member 2 following a separation of the user from the vehicle, e.g., following a fall or an unforeseen impact.

In any case, the abovementioned actuating and inflating means may be integrated in the protection device 1 according to the present invention, or located externally thereto.

Moreover, in connection with the internal layers 7, 8, and analogously to the two external layers 9, 10, it should be noted that the inflatable member may be obtained from a single internal layer and a single external layer, which are first glued with each other to define a single wall. Said wall can then be folded until overlapping and perimetrical joining of two portions thereof, with obtainment of the internal chamber.

According to another embodiment, the wall of the inflatable member may be made of a single layer. In practice, the inflatable member may be made of single-layer panels or sheets, opposed therebetween and perimetrically joined to form the internal chamber. In this case, the adhesive layer may be utilized to join only the perimetrical edges of the inflatable member.

### Comparative Tests

Hereinafter, referring to FIGS. 9-12, the results of traction tests performed by Mesdan Lab dynamometer on some samples of inflatable member wall, including respectively an adhesive layer based on conventional polyurethane different from polyurethane deriving from polycarbonate or polyether, and an adhesive layer based on polyurethane deriving from polycarbonate, will be described.

The tests were conducted in order to check resistance to detachment of the adhesive layer from a medium, like, e.g., from the internal layer, or from the external layer of the inflatable member.

In particular, samples having a length of 50 mm, in a nil pre-tensioning condition, were connected to a clamp movable at a rate of 100 mm/min. A 4/100 ID/FS [Kg] load cell was employed.

The results of two samples including one adhesive layer based on conventional polyurethane are shown in Table 1 reported herebelow, and are displayed in the diagrams of FIGS. 9-10.

TABLE 1

| Sample | Max Force [kg] | Max lengthening [%] | Breaking time [s] |
|---|---|---|---|
| 1 | 2.06 | 32.00 | 19.2 |
| 2 | 3.11 | 30.50 | 18.3 |

The results of two samples including one adhesive layer based on polyurethane deriving from polycarbonate are shown in Table 2 reported herebelow, and are displayed in the diagrams of FIGS. 11-12.

TABLE 2

| Sample | Max Force [kg] | Max lengthening [%] | Breaking time [s] |
|---|---|---|---|
| 1 | 17.15 | 96.00 | 28.8 |
| 2 | 17.36 | 68.40 | 20.5 |

From the results obtained, it emerged that a protection device including an adhesive layer of conventional polyurethane exhibits modest resistance to detachment from a medium, whereas a protection device including an adhesive layer of polyurethane obtained by reaction between diisocyanate and a polyol from polycarbonate exhibits excellent resistance to detachment from a medium.

Similar results are obtained by an adhesive layer based on polyurethane from polyether.

The subject-matter of the present disclosure has been hereto described with reference to preferred embodiments thereof. It is understood that there may be other embodiments referable to the same inventive concept, and all falling within the protective scope of the claims set forth hereinafter.

1. A protection device for the protection of a user, said protection device comprising:
an inflatable member; and
an adhesive layer adapted to fix layers or portions of said inflatable member, said adhesive layer including, or being of polyurethane deriving from polycarbonate and/or polyurethane deriving from polyether,
wherein
an internal chamber is defined in said inflatable member and wherein said inflatable member includes at least one first layer and one second layer defining a wall of the inflatable member;
said first layer is a mesh, fabric or cloth;
with respect to the internal chamber, said second layer is an external layer and said first layer is an internal layer;
said first layer and said second layer are overlapped and joined by said adhesive layer;
the protection device includes a thermoadhesive layer; and
said thermoadhesive layer is interposed between said adhesive layer and said first layer.

2. The protection device according to claim 1, wherein said adhesive layer is spread or coupled on an internal face of said second layer.

3. The protection device according to claim 1, wherein the second layer is made of a sheet of soft and gas-tight material.

4. The protection device according to claim 1, wherein the thermoadhesive layer is fixed to the adhesive layer under press at about 180-185° C. to foster adhesion and mutual gluing.

5. A method comprising:
using polyurethane deriving from polycarbonate and/or of polyurethane deriving from polyether for gluing at least two layers or portions of the inflatable member of the protection device according to claim 1.

6. The method according to claim 5, wherein the polyurethane deriving from polycarbonate and/or the polyurethane deriving from polyether is spread on, or coupled to an internal face of an external layer of the inflatable member.

7. A method for manufacturing a protection device including an inflatable member, wherein an adhesive layer is used to fix, or join, layers or portions of said inflatable member, said adhesive layer including, or being of polyurethane deriving from polycarbonate and/or polyurethane deriving from polyether, comprising:
overlapping and gluing a first layer of the inflatable member by said adhesive layer to a second layer to form a wall of the inflatable member, said first layer being a mesh, fabric or cloth; and
interposing a thermoadhesive layer between the adhesive layer and the first layer, wherein
with respect to an internal chamber, said second layer is an external layer and said first layer is an internal layer.

8. The method according to claim 7, wherein the adhesive layer is spread or coupled on the second layer to form a laminate.

9. The method according claim 7, wherein the first layer is overlapped and hot-glued to the second layer.

10. The method according to claim 7, wherein the thermoadhesive layer is fixed to the adhesive layer under press at about 180-185° C. to foster adhesion and mutual gluing.

11. The method according to claim 7, wherein the second layer is made of a sheet of soft and gas-tight material.

12. The protection device according to claim 1, wherein the thermoadhesive layer is fixed directly to the adhesive layer.

13. The protection device according to claim 1, wherein the thermoadhesive layer and the adhesive layer are made of two different adhesive materials.

14. The protection device according to claim 1, wherein the adhesive layer is first fixed to the external layer to form a composite layer and then each composite layer is overlapped and fixed to the internal layer by way of the thermoadhesive layer.

15. The protection device according to claim 14, wherein the external layers have a surface extension greater than the internal layers and wherein peripheral edges of the composite layers at which the internal layers are not present, are directly glued the one on the other in a gas-tight manner.

16. The method according to claim 7, wherein the thermoadhesive layer is fixed to the adhesive layer under press at about 135° C.-185° C. to foster adhesion and mutual gluing.

17. The method according to claim 7, wherein the thermoadhesive layer is fixed to the adhesive layer under press at about 140° C.-185° C. to foster adhesion and mutual gluing.

18. The method according to claim 7, wherein the adhesive layer is first fixed to the external layer to form a composite layer and then each composite layer is overlapped and fixed to the internal layer by way of the thermoadhesive layer.

19. The method according to claim 18, wherein the external layers have a surface extension greater than the internal layers and wherein peripheral edges of the composite layers at which the internal layers are not present, are directly glued the one on the other in a gas-tight manner.
